(19) United States
(12) Patent Application Publication
(10) Pub. No.: US 2016/0107239 A1
(43) Pub. Date: Apr. 21, 2016

(54) METHOD FOR MANUFACTURING NANOCOMPOSITE THERMOELECTRIC CONVERSION MATERIAL

(71) Applicants: TOYOTA JIDOSHA KABUSHIKI KAISHA, Toyota-shi, Aichi (JP); ADMATECHS COMPANY LIMITED, Miyoshi-shi, Aichi (JP)

(72) Inventors: Junya MURAI, Nissin-shi, Aichi (JP); Tomonari KOGURE, Toyota-shi, Aichi (JP); Yoichiro KAWAI, Okazaki-shi, Aichi (JP); Yoshinori OKAWAUCHI, Miyoshi-shi, Aichi (JP)

(73) Assignees: Admatechs Company Limited, Miyoshi-shi, Aichi (JP); TOYOTA JIDOSHA KABUSHIKI KAISHA, Toyota-shi, Aichi (JP)

(21) Appl. No.: 14/652,306

(22) PCT Filed: Jun. 16, 2014
(86) PCT No.: PCT/JP2014/065868

§ 371 Date: Jun. 15, 2015

(30) Foreign Application Priority Data
Jul. 11, 2013 (JP) 2013-145503

(51) Int. Cl. B22F 9/24; B22F 3/10

(52) U.S. Cl. CPC B22F 9/24; B22F 3/10; B22F 2009/245; B22F 2301/205; B22F 2302/45; B22F 2302/253; B22F 2302/256; B22F 2302/25; B22F 2301/052; B22F 2301/30; B22F 2304/05; B82Y 40/00

(57) ABSTRACT

This invention provides a method for manufacturing a nanocomposite thermoelectric conversion material in which phonon-scattering particles having a specific shape are dispersed, reducing thermal conductivity and increasing thermoelectric conversion performance. Said method for manufacturing a nanocomposite thermoelectric conversion material, in which oxide phonon-scattering particles are dispersed within the matrix of a thermoelectric conversion material, is characterized by including the following stages: a first stage in which, in a solution, the reduction of a salt is used to precipitate out/grow nanoparticles consisting of elements constituting a thermoelectric conversion material, the polymerization of a precursor is used to precipitate out/grow nanoparticles consisting of an oxide constituting phonon-scattering particles, and a mixture of said nanoparticles is collected; and a second stage in which a hydrothermal treatment is used to alloy said mixture into composite nanoparticles, which are then sintered. This method for manufacturing a nanocomposite thermoelectric conversion material is also characterized in that in the aforementioned first stage, nanoparticles consisting of a first group of elements that constitute the thermoelectric conversion material are precipitated out or grown before nanoparticles consisting of oxides of a second group of elements that constitute the phonon-scattering particles.

### TECHNICAL FIELD

The present invention relates to a method of production of a nanocomposite thermoelectric conversion material in which phonon scattering particles which have specific shapes are dispersed in a thermoelectric conversion material matrix.

### BACKGROUND ART

A nanocomposite thermoelectric conversion material is a thermoelectric conversion material which has a nanocomposite structure which has a thermoelectric conversion material as a matrix and which has nanosize phonon scattering particles dispersed in the matrix at nano order intervals.

The conversion efficiency of a thermoelectric conversion material is expressed by the following dimensionless performance index ZT. Further, α²×σ=PF is called an “output factor” or “electrical characteristic”.

ZT=α²×σ×T/κ . . . conversion efficiency (dimensionless performance index)

α²×σ=PF . . . output factor (electrical characteristic)

where α: Seebeck coefficient

### σ: Electroconductivity

### κ: Thermoconductivity

T: Absolute temperature

As shown in the topmost formula, the conversion efficiency is proportional to the reciprocal of the thermoconductivity κ, so the smaller the thermoconductivity, the higher the conversion efficiency. A nanocomposite thermoelectric conversion material has nanosize phonon scattering particles arranged at nano order intervals to augment the phonon scattering and lowers the phonon conduction in the thermoconductivity κ to lower the thermoconductivity κ.

To achieve a higher thermoelectric conversion performance, it is necessary to raise the phonon scattering effect by the phonon scattering particles. For example, PLT 1 describes to give the interfaces between the thermoelectric conversion material matrix and phonon scattering particles an interfacial roughness of 0.1 nm or more so as to raise the phonon scattering effect. Due to this, compared with before, the thermoconductivity falls and the thermoelectric conversion performance is improved.

However, there was a limit to the effect of roughness of the interfaces between the phonon scattering particles and thermoelectric conversion material matrix. That is, it had been anticipated that if not stopping with the roughness of the interfaces, but also making the shapes of the phonon scattering particles as a whole shapes advantageous to phonon scattering, the thermoconductivity would further fall and the thermoelectric conversion performance would be improved.

### CITATIONS LIST

### Patent Literature

PLT 1: Japanese Patent No. 4715953

### SUMMARY OF INVENTION

### Technical Problem

The present invention has as its object the provision of a method of producing a nanocomposite thermoelectric conversion material comprising making specific shapes of phonon scattering particles disperse in it to reduce the thermoconductivity and improve the thermoelectric conversion performance.

### Solution to Problem

To achieve this object, the method of production of the present invention provides a method of production of a nanocomposite thermoelectric conversion material comprising a matrix of a thermoelectric conversion material in which oxides are dispersed as phonon scattering particles, the method comprising
a first stage of precipitating and growing, as nanoparticles, elements which form the thermoelectric conversion material by reduction of salts in a solution and oxides which form the phonon scattering particles by polymerization of a precursor and recovering a mixture of these nanoparticles and

a second stage of alloying the mixture by hydrothermal treatment to obtain composite nanoparticles, then sintering them, wherein,

at the first stage, the nanoparticles of the first group of elements which form the thermoelectric conversion material are made to precipitate or grow in advance of the precipitation or growth of the nanoparticles of the second group of elements which form the phonon scattering particles.

### Advantageous Effects of Invention

According to the present invention, by making the nanoparticles of the first group of elements which form the thermoelectric conversion material precipitate or grow in advance of the precipitation or growth of the nanoparticles of the second group of elements which form the phonon scattering particles, phonon scattering nanoparticles precipitate and grow in a state filling the gaps or valleys between the thermoelectric conversion material nanoparticles which precipitated, grew, and aggregated in advance, the phonon scattering nanoparticles become shaped as multi-arc shapes comprised of two or more arcs and the following advantageous effects (1), (2), and (3) are obtained compared with the roughly spherical shapes obtained in the past.

(1) Compared with the same amount of spherical phonon scattering particles, the phonon scattering interfacial area remarkably increases and the thermoconductivity can be greatly decreased.

(2) Compared with conventional spherical phonon scattering particles, a smaller amount of phonon scattering particles can be used to achieve an equal effect of reduction of thermoconductivity, so when using electrical insulating phonon scattering particles, the fall in conductivity can be mitigated.

(3) Depending on the direction of incidence of the conduction carriers, a tunnel effect of the carriers occurs and the fall in the electroconductivity can be further decreased.

Due to the advantageous effects of the above (1), (2), and (3), the thermoelectric conversion efficiency ZT is greatly improved.

### BRIEF DESCRIPTION OF DRAWINGS

FIG. 1 shows the state where nanoparticles of thermoelectric conversion material-forming elements (first group of elements) precipitate and grow in advance, then phonon scattering particle-forming elements (second group of elements) which later precipitate and grow on their surfaces form two or more arc shapes reflecting the surface shapes of the nanoparticles of the first group of elements, wherein (1) shows the state of the composite nanoparticles and (2) shows the state of the bulk material after sintering.

FIG. 2 shows a contact angle θ when a double arc shaped phonon scattering nanoparticle of the present invention is formed on the surface of a thermoelectric conversion material-forming element nanoparticle.

FIG. 3 shows a density of interfaces with a thermoelectric conversion material matrix and a volume of nanoparticles for double arc shaped phonon scattering particles of the present invention and conventional spherical phonon scattering particles.

FIG. 4 schematically shows nanoparticles comprised of multi-arc shapes according to the present invention with (1) a large contact angle θ and (2) a small contact angle θ and (3) nanoparticles of a conventional shape comparing the carrier scattering and the tunnel effect.

FIG. 5 is a graph for explaining a reaction speed.

FIG. 6 shows the lattice thermoconductivity with respect to the volume ratio of phonon scattering particles of the nanocomposite thermoelectric conversion material comparing examples and comparative examples.

FIG. 7 shows the electroconductivity with respect to the volume ratio of phonon scattering particles of the nanocomposite thermoelectric conversion material comparing examples and comparative examples.

### DESCRIPTION OF PREFERRED EMBODIMENTS

The present invention provides a method of production of a nanocomposite thermoelectric conversion material comprising a matrix of a thermoelectric conversion material in which oxides are dispersed as phonon scattering particles, the method comprising

a first stage of precipitating and growing, as nanoparticles, elements which form the thermoelectric conversion material by reduction of salts in a solution and oxides which form the phonon scattering particles by polymerization of a precursor and recovering a mixture of these nanoparticles and

a second stage of alloying the mixture by hydrothermal treatment to obtain composite nanoparticles, then sintering them, wherein,

at said first stage, the nanoparticles of the first group of elements which form the thermoelectric conversion material are made to precipitate or grow in advance of the precipitation or growth of the nanoparticles of the second group of elements which form the phonon scattering particles.

In the present invention, at the first stage, the method of making the nanoparticles of the thermoelectric conversion material-forming elements precipitate or grow in advance of the precipitation or growth of the nanoparticles of the phonon scattering particle-forming oxides is based on any of the following Modes A, B, and C.

### Mode A

The following steps (1) and (2) are successively performed:

(1) A solution of salts of the first group of elements which form the thermoelectric conversion material and a precursor of the second group of elements which form the phonon scattering particles is formed so as to satisfy the following condition 1.

Condition 1: The salts and the precursor are selected so that in the solution in the presence of the same reducing agent, the speed by which the salts are reduced and the nanoparticles of the first group of elements precipitate becomes greater than the speed by which the precursor polymerizes and the nanoparticles of the second group of element oxides precipitate.

(2) A reducing agent is mixed with the solution to make the nanoparticles of the first group of elements precipitate from the salts, simultaneously the precursor is polymerized to make the nanoparticles of the second group of element oxides precipitate, and the mixture of these nanoparticles is recovered.

### Mode B

The following steps (1) and (2) are successively performed:

(1) A first solution of salts of the first group of elements which form the thermoelectric conversion material and a second solution of a precursor of the second group of elements which form the phonon scattering particles are formed so as to satisfy the following condition 1.

Condition 1: The salts and the precursor are selected so that in the presence of the same reducing agent, the speed by which the salts are reduced and the nanoparticles of the first group of elements precipitate becomes greater than the speed by which the precursor polymerizes and the nanoparticles of the second group of element oxides precipitate.

(2) A reducing agent is mixed with the first solution to make the nanoparticles of the first group of elements precipitate, then the second solution is charged to make the nanoparticles of the second group of element oxides precipitate, and the mixture of these nanoparticles is recovered. Preferably, after charging, the mixture is stirred and aged for 1 to 48 hr. In the case of an alkoxide, water is charged so as to promote the sol-gel reaction to an extent not causing turbidity.

### Mode C

The following steps (1) and (2) are successively performed:

(1) A first solution of salts of the first group of elements which form the thermoelectric conversion material and a second solution of a precursor of the second group of elements which form the phonon scattering particles are formed so as to satisfy the following condition 1.

Condition 1: The salts and the precursor are selected so that in the presence of the same reducing agent, the speed by which the salts are reduced and the nanoparticles of the first group of elements precipitate becomes greater than the speed by which the precursor polymerizes and the nanoparticles of the second group of element oxides precipitate.

(2) A reducing agent is mixed with the first solution to make the nanoparticles of the first group of elements precipitate, this is allowed to stand to cause aggregation, then the second solution is charged to make the nanoparticles of the second group of element oxides precipitate, and the mixture of these nanoparticles is recovered. Preferably, the standing is performed for 1 to 48 hr to cause sufficient aggregation. Preferably, after charging the second solution, ultrasonic waves are used to promote sufficient dispersion, then the mixture is stirred and aged for 1 to 48 hr. In the case of an alkoxide, water is charged so as to promote the sol-gel reaction to an extent not causing turbidity.

The second stage in the method of the present invention specifically successively performs the following steps (3) and (4).

(3) The mixture is hydrothermally treated to alloy the nanoparticles of the first group of elements and the nanoparticles of the second group of element oxides to obtain composite nanoparticles. The temperature of the hydrothermal treatment is generally 175 to 550° C., preferably 240 to 350° C., more preferably 240 to 300° C. Normally, the mixture of nanoparticles which is used for the hydrothermal treatment is washed to remove impurity ingredients. After the hydrothermal treatment, the mixture is dried to remove the solvent and is recovered as a powder of composite nanoparticles.

(4) The composite nanoparticles are sintered to obtain a bulk material. The temperature of the sintering is generally 250 to 550° C., preferably 300 to 500° C., more preferably 300 to 450° C.

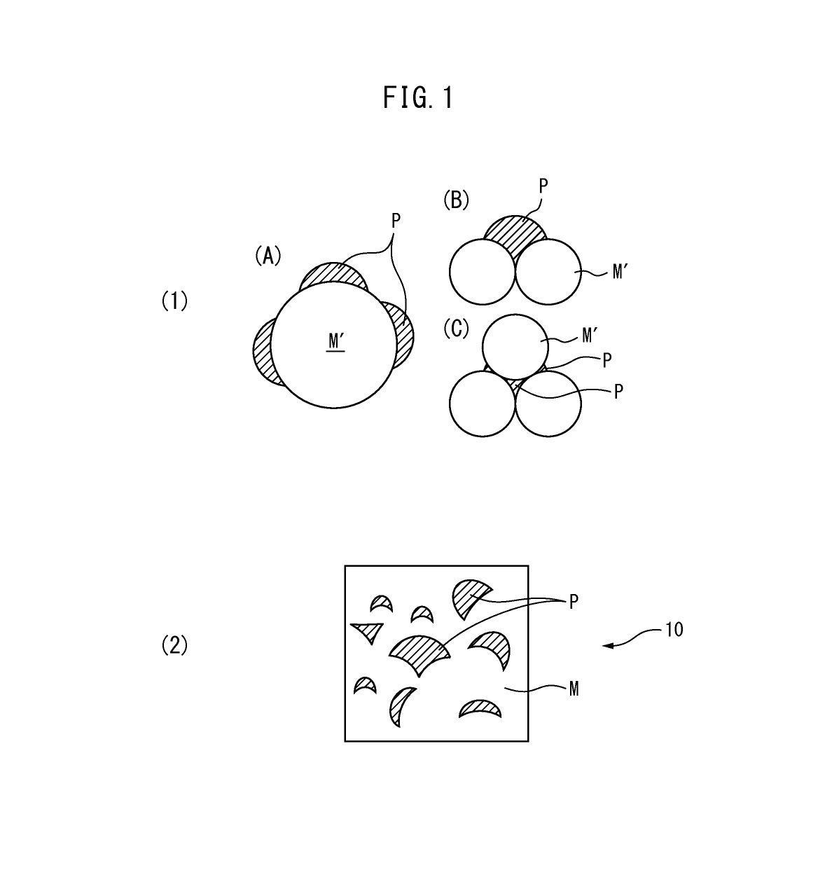

Referring to FIG. 1, (1) the state of precipitation and growth of composite nanoparticles and (2) the state of dispersion of phonon scattering particles in the sintered body of the present invention will be explained. First, as shown in FIG. 1, (1), at the first stage of the present invention, spherical nanoparticles M′ of the thermoelectric conversion material are first precipitated and grown, then (A) phonon scattering nanoparticles P precipitate on the surface of individual thermoelectric conversion material nanoparticles M′ and grow into double arc (crescent) shapes comprised of two arcs in cross-section, (B) phonon scattering nanoparticles P precipitate in the valleys between two thermoelectric conversion material nanoparticles M′ and grow into triple arc shapes comprised of three arcs in cross-section, or (C) phonon scattering particles P precipitate in the valleys formed by contact of two of three thermoelectric conversion material nanoparticles M′ or in the holes formed by contact of three and grow into triple arc shapes comprised of three arcs in cross-section. In this way, a mixture of thermoelectric conversion material nanoparticles M′ and phonon scattering nanoparticles P is obtained.

At the second stage of the present invention, if alloying the composite nanoparticles C by a hydrothermal reaction, then sintering them, as shown in FIG. 1, (2), a nanocomposite thermoelectric conversion material 10 comprised of a matrix M of thermoelectric conversion material in which double or triple arc shaped phonon scattering particles P are dispersed is obtained.

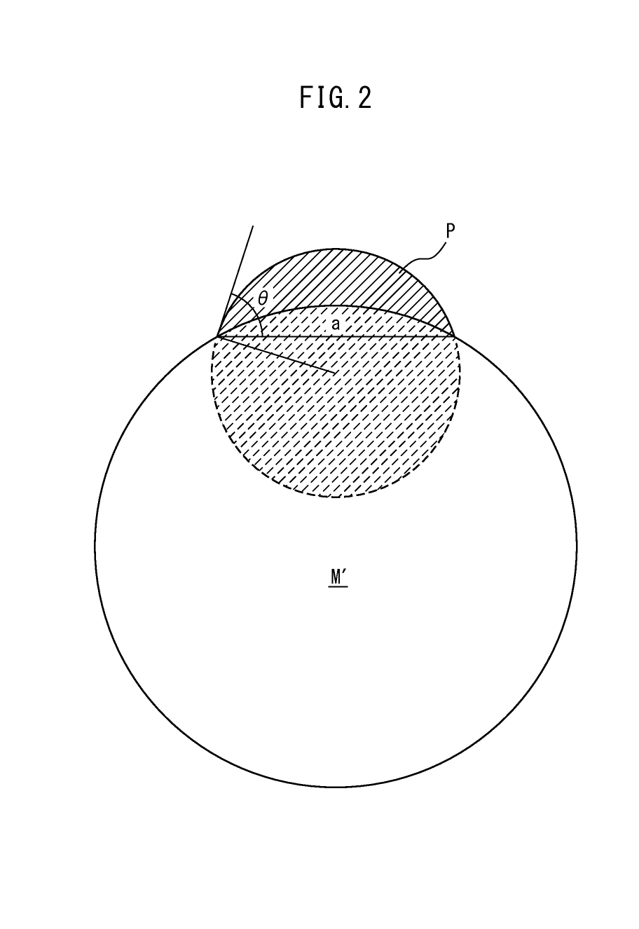

Referring to FIG. 2, the contact angle θ between the two end parts of the double arc shape (crescent shape) cross-section of the phonon scattering nanoparticles P which precipitate and grow on the surfaces of the thermoelectric conversion material nanoparticles M′ and the surfaces of the thermoelectric conversion material nanoparticles M′ will be explained.

Preferably, the contact angle θ is 1°<θ<90° and the diameter “a” of the nanoparticles is 1 nm<a<50 nm, more preferably θ<60° and a<15 nm.

If θ becomes less than 90°, even with the same volume, the phonon scattering interfacial area greatly increases. If the nanoparticle diameter “a” becomes small, similarly the interfacial area increases.

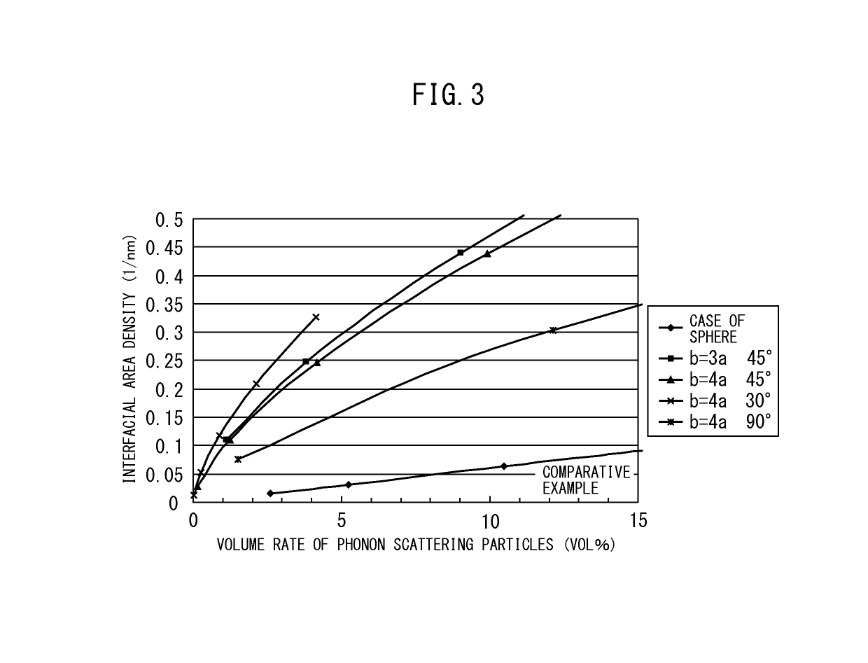

FIG. 3 shows the relationship between the volume rate (vol %) and interfacial area density of phonon scattering particles in a heat exchanger thermoelectric conversion material by calculated values in the case of changing the diameter “b” of the multi-arc shaped nanoparticles of the present invention in various ways. Compared with the conventional spherical shape nanoparticles, it is learned that the multi-arc shape of the present invention causes the nanoparticle interfacial area to greatly increase. In the figure, “a” is the diameter of a phonon scattering particle.

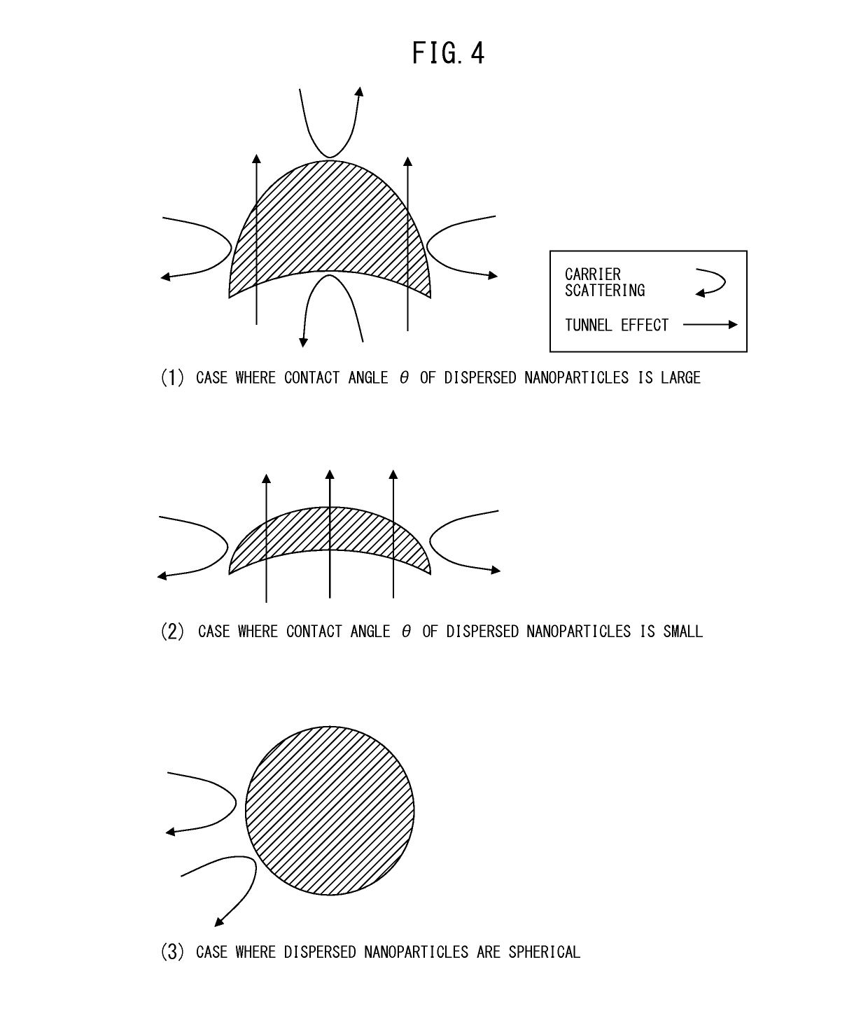

Furthermore, if in the ranges of θ and “a”, depending on the incident direction of the carriers, a size where a tunnel effect occurs (layer of several atoms to several nm) may be included. Regarding this, FIG. 4 schematically shows the state of carrier scattering and the tunnel effect for the multi-arc shaped phonon scattering particles which are formed by the present invention in (1) and (2) and the conventional spherical phonon scattering particles in (3). According to the present invention, a size where the tunnel effect can arise (cross-sectional thickness of phonon scattering particles) is possible (1) at the two end parts of the crescent shape cross-section in the case of a large contact angle θ and (2) at the crescent shape cross-section as a whole in the case of a small contact angle θ. With the conventional spherical shape (3), a size where the tunnel effect occurs is difficult to obtain.

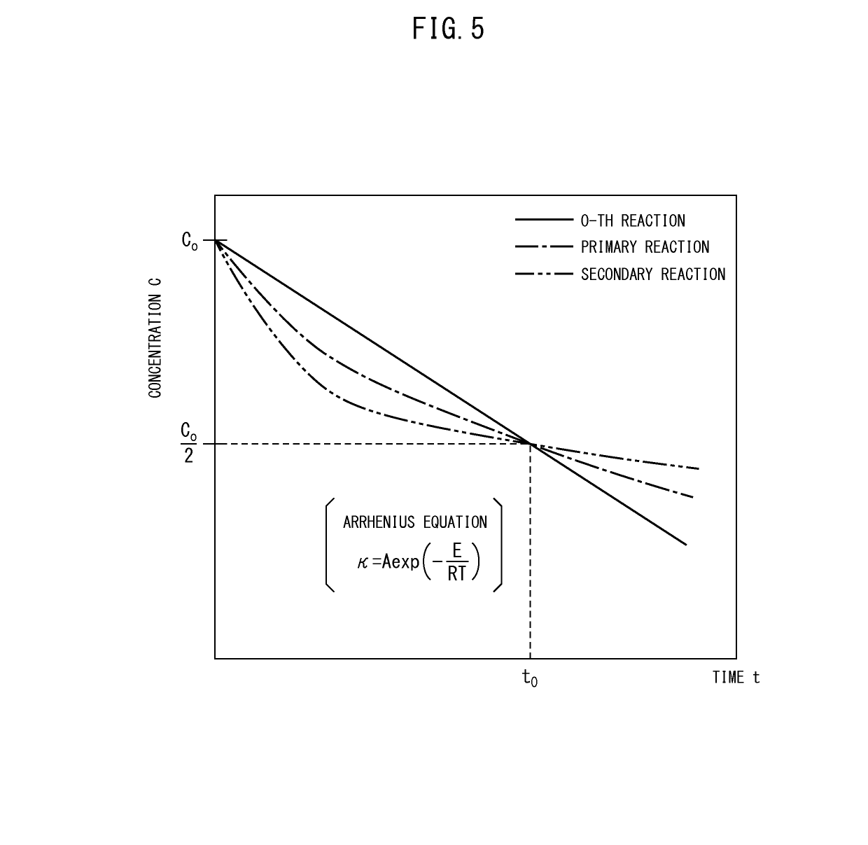

Note that, referring to FIG. 5, the “speed of precipitation” in the Modes A and B of the present invention will be explained. As shown in FIG. 5, in general, in a synthesis reaction, the slant of the graph which shows the relationship between the time and rate of drop of the concentration of the reaction product (reaction rate) will be caused the “reaction speed”. For example, in the case of a primary reaction of FIG. 5, ln(C/C0)=−kt, where C: concentration (time “t”), C0: initial concentration (time “t”=0), t: time elapsed from start of reaction, and k: reaction speed constant. From the Arrhenius equation, k=Aexp (−E/RT).

If comparing the Modes A, B, and C of the present invention, they have the following characteristics relative to each other:

Mode A . . .

Advantage: Small diameter “a” of phonon scattering particles

Shortcoming: Large contact angle θ

Mode B

Advantage: Small contact angle θ. Therefore, large interfacial area density.

Shortcoming: Medium extent of diameter “a” of phonon scattering particles

Mode C

Advantage: Large number of arcs. Therefore, large interfacial area with same diameter of phonon scattering particles

Shortcoming: Large diameter “a” of phonon scattering particles

### EXAMPLES

Nanocomposite thermoelectric conversion materials comprised of a thermoelectric conversion material matrix of BiTeSb alloy in which cross-sectional multi-arc shaped phonon scattering particles were dispersed at 0.5 to 11 vol % were fabricated according to the Modes A, B, and C of the present invention under the conditions which are shown in Table 1 and were measured for contact angle θ, nanoparticle diameter “a”, lattice thermoconductivity κ, and electroconductivity. The measurement results are also shown in Table 1.

Fabrication of Samples of Invention Examples Starting Materials of Matrix Thermoelectric Conversion Material

As the matrix thermoelectric conversion material of the nanocomposite thermoelectric conversion material, the following starting materials were used as salts of the first group of elements (Bi, Sb, Te) which form the

BiTeSb thermoelectric conversion material common to the different modes:

Salts of First Group of Elements

Bi source: BiCl₃ 0.24 g

Sb source: SbCl₃ 0.68 g

Te source: TeCl₄ 1.51 g

Below, the Modes A, B, C will each be explained.

### Mode A: Examples 1 to 7

Materials for Phonon Scattering Particles

As shown in Examples 1 to 7 of Table 1, as the precursor of the second group of element oxides (SiO₂) which forms the phonon scattering particles, TEOS (tetraethoxysilane: Si(OC₂H₅)₄) was used.

Precursor of Second Group of Element Oxides SiO₂ source: TEOS 0.14 g

As the solvent, as shown in Examples 1 to 7 of Table 1, either methanol, ethanol, 1-propanol, or 2-propanol was used.

First, as the first stage, the following steps (1) and (2) were successively performed.

(1) Formation of Solutions

The salts of the first group of elements and the precursor of the second group of element oxides were dissolved in solvents: 100 ml to prepare the solutions of Examples 1 to 7 which are shown in Table 1. To each solution, as the reducing agent, a solution of either NaBH₄ (1.59 g), N₂H₄.H₂O (2.10 g), or ascorbic acid (7.40 g) dissolved in 100 ml of solvent was used as shown in Table 1.

The Condition 1 required for the Mode A is satisfied as follows:

Condition 1: In each solution of Examples 1 to 7, the speed by which the first salts (BiCl₃, SbCl₃, TeCl₄) are reduced by the reducing agent and the first group of elements (Bi, Sb, Te) precipitate is greater than the speed by which the precursor (TEOS) polymerizes and the second group of element oxides (SiO₂) precipitate.

(2) Precipitation and Growth of Nanoparticles

Into each solution of Examples 1 to 7, the reducing agent solution which is shown in Table 1 was dropped to make the first group of elements (Bi, Sb, Te) precipitate while making the second group of element oxides (SiO₂) precipitate. At that time, as shown in FIG. 1, (1), the large precipitation speed first group of elements (Bi, Sb, Te) first grew to spherical nanoparticles and the nanoparticles of the second group of element oxides (SiO₂) then grew in multi-arc shapes on the surfaces of the nanoparticles or in the gaps or valleys between the nanoparticles.

A slurry of each of the obtained Examples 1 to 7 in a solvent was filtered and washed by water 500 ml, then was further filtered and washed by the same solvent 300 ml. Due to this, a mixture of nanoparticles was obtained.

Next, as the second stage, the following steps (3) and (4) were successively performed.

(3) Hydrothermal Treatment: Formation of Composite Nanoparticles

Each above mixture was placed in a sealed autoclave and hydrothermally treated to make it alloy at 240° C. for 48 hr. After that, it was made to dry in a nitrogen gas flow atmosphere. Due to this, a powder of composite nanoparticles of BiTeSb alloy nanoparticles and SiO₂ nanoparticles was recovered.

(4) Sintering: Completion of Nanocomposite Thermoelectric Conversion Material

Each composite nanoparticle powder was sintered at 360° C. by spark plasma sintering. Due to this, a bulk material of nanocomposite thermoelectric conversion material of a BiTeSb thermoelectric conversion material matrix in which SiO₂ nanoparticles are dispersed as phonon scattering particles was obtained.

A TEM was used to observe Examples 1 to 7 to measure the contact angles 0 and diameters “a” of SiO₂. These are shown in Table 1. The obtained sintered bodies were measured for lattice thermoconductivity and electroconductivity. The results are shown in Table 1.

### Mode B: Examples 8 to 14

Starting Materials of Phonon Scattering Particles

Starting Materials of Phonon Scattering Particles

As shown in Examples 8 to 14 of Table 1, as precursors of the second group of element oxides (SiO₂, Bi₂O₃, Sb₂O₃, TeO₂, TiO₂) which form the phonon scattering particles, respectively sodium silicate solution no. 3, TEOS, Bi ethoxide, Sb ethoxide, Te ethoxide, and Ti alkoxide were used.

Precursors of Second Group of Element Oxides

SiO₂ source
TEOS 0.14
sodium silicate 0.08

Bi₂O₃ source: Bi ethoxide 0.23 g

Sb₂O₃ source: Sb ethoxide 0.17 g

TeO₂ source: Te ethoxide 0.21 g

TiO₂ source: Ti alkoxide 0.15 g

As the solvent, as shown in Examples 8 to 14 of Table 1, 2-propanol was used.

First, as the first stage, the following steps

(1) and (2) were successively performed.

(1) Formation of Solutions

The salts of the first group of elements were dissolved in the solvent 2-propanol: 100 ml to obtain a first solution, while the precursor of the second group of element oxides was dissolved in the solvent 2-propanol: 100 ml to obtain a second solution. To each solution, as the reducing agent, a solution of either NaBH₄ (1.59 g) or N₂H₄.H₂O (2.10 g) dissolved in the solvent 2-propanol: 100 ml was used as shown in Table 1.

The Condition 1 required for Mode B is satisfied as follows:

Condition 1: In each solution of Examples 8 to 14, the speed by which the salts (BiCl₂, SbCl₃, TeCl₄) are reduced by the reducing agent and the first group of elements (Bi, Sb, Te) precipitate is greater than the speed by which the precursor (sodium silicate solution no. 3, TEOS, Bi ethoxide, Sb ethoxide, Te ethoxide, or Ti alkoxide) polymerizes and the second group of element oxides (SiO₂, Bi₂O₂, Sb₂O₂, TeO₂, TiO₂) precipitate.

(2) Precipitation and Growth of Nanoparticles

Into each first solution of Examples 8 to 14, the reducing agent solution which is shown in Table 1 was dropped to make the first group of elements (Bi, Sb, Te) precipitate, then the second solution was charged to make the second group of element oxides (SiO₂, Bi₂O₃, Sb₂O₃, TeO₂, TiO₂) precipitate. At that time, as shown in FIG. 1, (1), the large precipitation speed first group of elements (Bi, Sb, Te) first precipitated and grew to spherical nanoparticles and the nanoparticles of the second group of element oxides (SiO₂, Bi₂O₂, Sb₂O₃, TeO₂, TiO₂) then grew in multi-arc shapes on the surfaces of the nanoparticles or in the gaps or valleys between the nanoparticles.

A slurry of each of the obtained Examples 8 to 14 in 2-propanol was filtered and washed by water: 500 ml, then was further filtered and washed by 2-propanol: 300 ml. Due to this, a mixture of nanoparticles was obtained.

Next, as the second stage, the following steps (3) and (4) were successively performed.

(3) Hydrothermal Treatment: Formation of Composite Nanoparticles

Each above mixture was placed in a sealed autoclave and hydrothermally treated to make it alloy at 240° C. for 48 hr. After that, it was made to dry in a nitrogen gas flow atmosphere. Due to this, a powder of composite nanoparticles of BiTeSb alloy nanoparticles and SiO₂, Bi₂O₂, Sb₂O₂, TeO₂ or TiO₂ nanoparticles was recovered.

(4) Sintering: Completion of Nanocomposite

Thermoelectric Conversion Material

Each composite nanoparticle powder was sintered at 360° C. by spark plasma sintering. Due to this, a bulk material of nanocomposite thermoelectric conversion material of a BiTeSb thermoelectric conversion material matrix in which SiO₂ nanoparticles, Bi₂O₂ nanoparticles, Sb₂O₂ nanoparticles, TeO₂ nanoparticles, or TiO₂ nanoparticles are dispersed as phonon scattering particles was obtained.

A TEM was used to observe Examples 8 to 14 to measure the contact angles θ and diameters “a” of SiO₂, Bi₂O₂, Sb₂O₂, Te0₂, or TiO₂. These are shown in Table 1. The obtained sintered bodies were measured for lattice thermoconductivity and electroconductivity. The results are shown in Table 1.

### Mode C: Examples 15 to 16

Starting Materials of Phonon Scattering Particles

Starting Materials of Phonon Scattering Particles

As shown in Examples 15 to 16 of Table 1, as the precursors of the second group of element oxides (SiO₂,

Sb₂O₂) which form the phonon scattering particles, respectively TEOS and Sb ethoxide were used.

Precursors of Second Group Element Oxides

SiO₂ source: TEOS 0.14 g

Sb₂O₂ source: Sb ethoxide 0.17 g

As the solvent, as shown in Examples 15 to 16 of Table 1, ethanol was used.

First, as the first stage, the following steps (1) and (2) were successively performed.

(1) Formation of Solutions

The salts of the first group of elements were dissolved in the solvent ethanol: 100 ml to obtain a first solution, while the precursor of the second group of element oxides was dissolved in the solvent ethanol: 100 ml to obtain a second solution. To each solution, as the reducing agent, a solution of N₂H₄.H₂O (2.10 g) dissolved in the solvent ethanol: 100 ml was used as shown in Table 1.

(2) Precipitation and Growth of Nanoparticles Into each first solution of Examples 15 to 16, the reducing agent solution which is shown in Table 1 was dropped to make the first group of elements (Bi, Sb, Te) precipitate. The mixture was allowed to stand for 48 hours to make the nanoparticles aggregate. After that, the second solution was charged to make the second group of element oxides (SiO₂, Sb₂O₃) precipitate. At that time, as shown in FIG. 1, (1), the first group of elements (Bi, Sb, Te) had already precipitated and grew to spherical nanoparticles in state. The nanoparticles of the second group of element oxides (SiO₂, Sb₂O₃) grew in multi-arc shapes on the surfaces of the nanoparticles or in the gaps or valleys between the nanoparticles.

Ethanol slurries of the obtained Examples 15 to 16 were filtered and washed by water: 500 ml, then were further filtered and cleaned by ethanol: 300 ml. Due to this, mixtures of nanoparticles were obtained.

Next, as a second stage, the following steps (3) and (4) were successively performed:

(3) Hydrothermal Treatment: Formation of Composite Nanoparticles

Each mixture was placed in a sealed autoclave and hydrothermally treated at 240° C. for 48 hr to make it alloy. After that, this was made to dry in a nitrogen gas flow atmosphere. Due to this, a powder of composite nanoparticles of BiTeSb alloy nanoparticles and SiO₂ or Sb₂O₃ nanoparticles was recovered.

(4) Sintering: Completion of Nanocomposite Thermoelectric Conversion Material

The composite nanoparticles powder was sintered at 360° C. by spark plasma sintering. Due to this, a bulk material of nanocomposite thermoelectric conversion material comprised of a BiTeSb thermoelectric conversion material matrix in which SiO₂ nanoparticles or Sb₂O₃ nanoparticles were dispersed as phonon scattering particles was obtained.

A TEM was used to observe Examples 15 to 16 to measure the contact angles θ and diameters “a” of SiO₂ and Sb₂O₂. These are shown in Table 1. The obtained sintered bodies were measured for lattice thermoconductivity and electroconductivity. The results are shown in Table 1.

### Comparative Examples

For comparison, nanocomposite thermoelectric conversion materials each comprised of an alloy matrix in which phonon scattering particles constituted by conventional spherical SiO₂ nanoparticles (commercially available product: particle size 5 nm or 15 nm) were dispersed to 10 to 15 vol % were fabricated.

Fabrication Conditions of Comparative Examples Starting Materials for Matrix Thermoelectric Conversion Material

Starting materials common to Examples 1 to 16 were used.

Salts of First Group of Elements

Bi source: BiCl₃ 0.24 g

Sb source: SbCl₂ 0.68 g

Te source: TeCl₄ 1.51 g

Phonon Scattering Particles

Commercially available SiO₂ (particle size 5 nm or 15 nm): 0.034 to 0.054 g (case of 15 vol%) was used.

In 100 ml of ethanol, first salts of the first group of elements and the phonon scattering particles were charged. To the obtained solution, a reducing agent constituted by NaBH₄: 1.59 g in 100 ml solution was dropped as a reducing agent solution to obtain a mixture of nanoparticles of the first group of elements (Bi, Sb,

Te) and SiO₂ nanoparticles. This mixture was placed in a sealed autoclave and hydrothermally treated at 240° C. for 48 hr to make it alloy. After that, this was made to dry in a nitrogen gas flow atmosphere. Due to this, a powder of composite nanoparticles of BiTeSb alloy nanoparticles and SiO₂ nanoparticles was recovered.

This composite nanoparticles powder was sintered at 360° C. by spark plasma sintering. At that time, a bulk material of nanocomposite thermoelectric conversion material wherein the SiO₂ nanoparticles were maintained as they were and dispersed in a BiTeSb thermoelectric conversion material matrix was obtained.

TABLE 1

| | | | | | Phonon scattering | | | | Lattice heat | Electro- |
|---|---|---|---|---|---|---|---|---|---|---|
| | | | Reducing | | particles | | Contact | a | conduction | conductivity |
| Class | Mode | Example | agent | Solvent | Material | Type | angle θ | (nm) | rate (W/m/K) | (S/cm) |
| Inv. ex. | A | 1 | NaBH₄ | Methanol | TEOS | SiO₂ | 74 | 8 | 0.13 | 421 |
| | | 2 | NaBH₄ | Ethanol | TEOS | SiO₂ | 86 | 7 | 0.12 | 465 |
| | | 3 | NaBH₄ | 1-propanol | TEOS | SiO₂ | 67 | 4 | 0.09 | 432 |
| | | 4 | NaBH₄ | 2-propanol | TEOS | SiO₂ | 72 | 5 | 0.11 | 425 |
| | | 5 | N₂H₄•H₂O | 2-propanol | TEOS | SiO₂ | 53 | 8 | 0.15 | 413 |
| | | 6 | Ascorbic acid | 2-propanol | TEOS | SiO₂ | 55 | 10 | 0.16 | 448 |
| | | 7 | NaBH₄ | Ethanol | TEOS | SiO₂ | 78 | 7 | 0.13 | 435 |
| | B | 8 | N₂H₄•H₂O | 2-propanol | Sodium silicate | SiO₂ | 28 | 12 | 0.13 | 411 |
| | | | | | solution no. 3 | | | | | |
| | | 9 | N₂H₄•H₂O | 2-propanol | TEOS | SiO₂ | 21 | 9 | 0.09 | 479 |
| | | 10 | NaBH₄ | 2-propanol | TEOS | SiO₂ | 19 | 13 | 0.11 | 482 |
| | | 11 | NaBH₄ | 2-propanol | Bi ethoxide | Bi₂O₃ | 36 | 7 | 0.12 | 445 |
| | | 12 | NaBH₄ | 2-propanol | Sb ethoxide | Sb₂O₃ | 22 | 9 | 0.11 | 455 |
| | | 13 | NaBH₄ | 2-propanol | Te ethoxide | TeO₂ | 45 | 15 | 0.19 | 402 |
| | | 14 | NaBH₄ | 2-propanol | Ti alkoxide | TiO₂ | 41 | 17 | 0.21 | 386 |
| | C | 15 | N₂H₄•H₂O | Ethanol | TEOS | SiO₂ | 15 | 22 | 0.29 | 453 |
| | | 16 | N₂H₄•H₂O | Ethanol | Sb ethoxide | Sb₂O₃ | 13 | 25 | 0.26 | 422 |

| | | | | | |
|---|---|---|---|---|---|
| Comp. ex. | SiO₂ | Spherical | 5.15 | 0.58 | 392 |

As shown in Table 1 , the invention examples have much lower thermoconductivity and higher electroconductivity compared with the comparative examples. The Modes A, B, and C will be compared.

The contact angle θ becomes smaller in the order of the Modes A>B>C.

The particle diameter “a” becomes larger in the order of the Modes A<B<C.

This is because in each case, the specific surface area of the thermoelectric conversion material nanoparticles becomes greater in the order of A<B<C. Due to this, the lattice thermoconductivity and electroconductivity become higher overall.

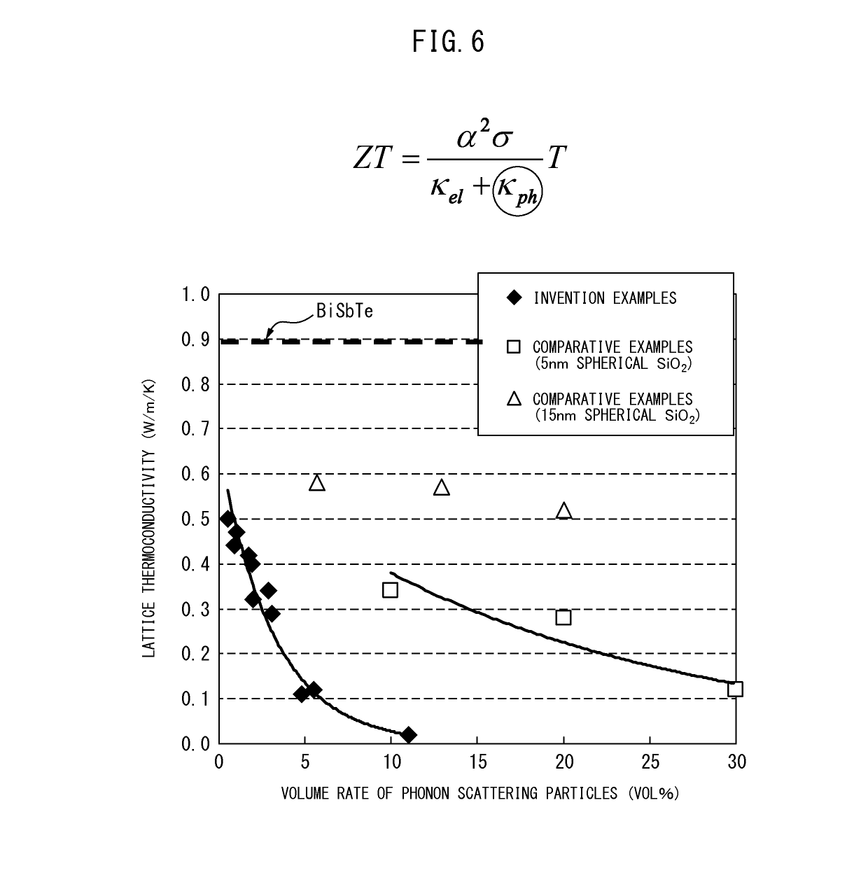

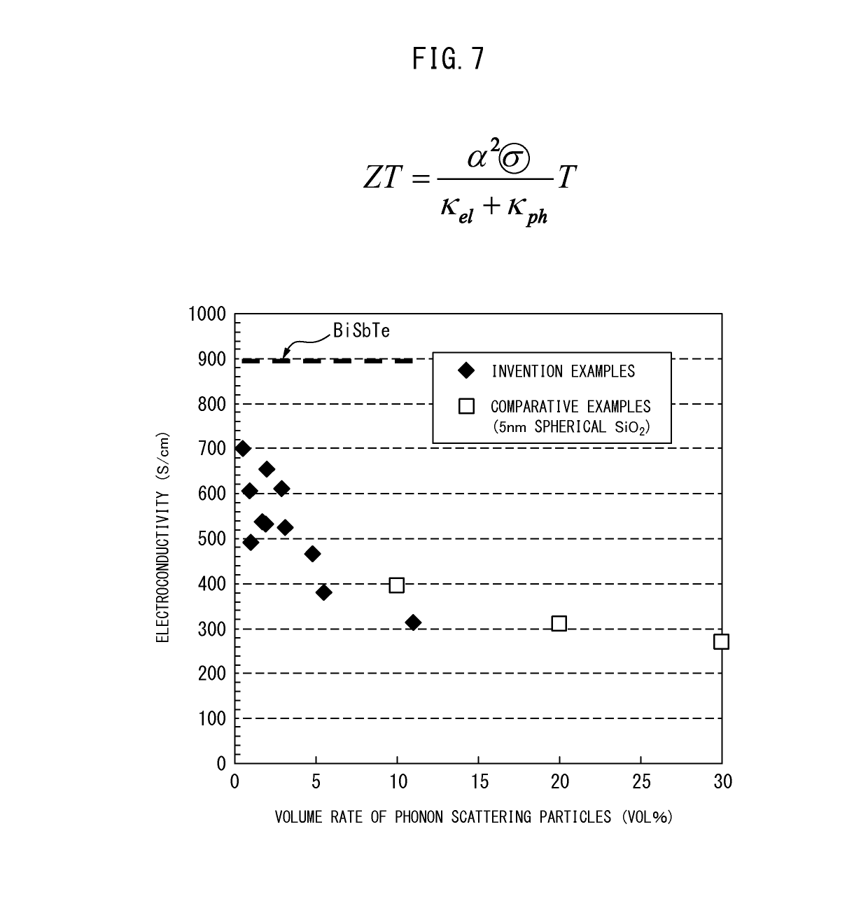

FIGS. 6 and 7 show the relationship between the volume ratio of the phonon scattering particles and characteristics of the nanocomposite thermoelectric conversion material for the invention examples and comparative examples.

First, FIG. 6 plots the lattice thermoconductivity with respect to the volume rate of the phonon scattering particles. The volume rate is 0.5 to 11 vol % in the invention examples and 5 to 20 vol % (particle size 5 nm) and 10 to 30 vol % (particle size 15 nm) in the comparative examples. As a representative of the invention examples, the results of Mode B are shown (same for FIGS. 6, 7, and 8).

In the figure, the top horizontal broken line (labeled as “BiSbTe”) is the lattice thermoconductivity κₚₕ in the case of a BiSbTe thermoelectric conversion material (matrix material of present invention) alone without containing phonon scattering particles. It was 0.90 W/m/K.

As opposed to this, the comparative examples where the spherical phonon scattering particles (SiO₂) are dispersed have a lattice thermoconductivity κₚₕ of 0.57 to 0.52 W/m/K in the case of a particle size 15 nm of phonon scattering particles (volume rate 10 to 30 vol %) and a lattice thermoconductivity κₚₕ of 0.34 to 0.12 W/m/K in the case of a particle size 5 nm (volume rate 5 to 20 vol %). The dispersion of the phonon scattering particles causes a large drop.

Furthermore, the invention examples in which the multi-arc shaped phonon scattering particles (volume rate 0.5 to 11 vol %) are dispersed become larger in degree of drop, that is, 0.5 to 0.02 W/m/K, along with the increase in the phonon scattering particles volume rate.

The lattice thermoconductivity κₚₕ falls extremely greatly by a small volume rate.

In this way, according to the present invention, the multi-arc shaped phonon scattering particles caused the phonon scattering interfaces to greatly increase (see FIG. 3) and thereby the lattice thermoconductivity κₚₕ to greatly drop.

Next, FIG. 7 plots the electroconductivity with respect to the volume rate of phonon scattering particles. In the figure, the top horizontal broken line (labeled as “BiSbTe”) shows the electroconductivity σ in the case of a BiSbTe thermoelectric conversion material alone not containing phonon scattering particles (matrix material in the present invention). This was 900 S/cm.

As opposed to this, the comparative examples in which spherical phonon scattering particles (SiO₂, particle size 5 nm, volume rate 10 to 30 vol %) are dispersed had an electroconductivity σ of 270 to 390 S/cm, while the invention examples in which multi-arc shaped phonon scattering particles (volume rate 0.5 to 11 vol %) are dispersed exhibited a value of 320 to 700 S/cm or higher than the comparative examples regardless of photon scattering particles being dispersed by a volume rate higher than the comparative examples.

As a result, according to the present invention, it can be seen that multi-arc shaped phonon scattering particles change on the same curve as the spherical phonon scattering particles of the comparative examples despite the interfacial area density being high. This is because the multi-arc shaped phonon scattering particles of the present invention are suppressed in increase of carrier scattering (=fall in electroconductivity) due to the increase in interfaces due to the tunnel effect (see FIGS. 4, (1) and (2)).

### INDUSTRIAL APPLICABILITY

According to the present invention, there is provided a method of producing a nanocomposite thermoelectric conversion material comprising causing dispersion of multi-arc shaped phonon scattering particles in it to reduce the thermoconductivity and improve the thermoelectric conversion performance.

1. A method of production of a nanocomposite thermoelectric conversion material comprised of a matrix of a thermoelectric conversion material in which an oxide is dispersed as phonon scattering particles,
said method of production of a nanocomposite thermoelectric conversion material comprising
a first stage of precipitating and growing, as nanoparticles, elements which form the thermoelectric conversion material by reduction of salts in a solution and oxides which form the phonon scattering particles by polymerization of a precursor by using a same reducing agent, and recovering a mixture of these nanoparticles and
a second stage of alloying said mixture by hydrothermal treatment to obtain composite nanoparticles, then sintering them, wherein,
at said first stage, the nanoparticles of the first group of elements which form the thermoelectric conversion material is made to precipitate or grow in advance of the precipitation or growth of the nanoparticles of the second group of elements which form the phonon scattering particles.

2. The method of production of a nanocomposite thermoelectric conversion material according to claim 1 wherein
said first stage performs treatment by any of the following A, B, and C.
A: The following steps (1) and (2) are successively performed:
(1) A solution of salts of the first group of elements which form the thermoelectric conversion material and a precursor of the second group of elements which form the phonon scattering particles is formed so as to satisfy the following condition 1. Condition 1: The salts and the precursor are selected so that in said solution in the presence of the same reducing agent, the speed by which the salts are reduced and the nanoparticles of the first group of elements precipitate becomes greater than the speed by which the precursor polymerizes and the nanoparticles of the second group of element oxides precipitate.
(2) A reducing agent is mixed with said solution to make the nanoparticles of the first group of elements precipitate from the salts, simultaneously the precursor is polymerized to make the nanoparticles of the second group of element oxides precipitate, and the mixture of these nanoparticles is recovered.
Alternatively,
B: The following steps (1) and (2) are successively performed:
(1) A first solution of salts of the first group of elements which form the thermoelectric conversion material and a second solution of a precursor of the second group of elements which form the phonon scattering particles are formed so as to satisfy the following condition 1.
Condition 1: The salts and the precursor are selected so that in the presence of the same reducing agent, the speed by which the salts are reduced and the nanoparticles of the first group of elements precipitate becomes greater than the speed by which the precursor polymerizes and the nanoparticles of the second group of element oxides precipitate.
(2) A reducing agent is mixed with the first solution to make the nanoparticles of the first group of elements precipitate, then the second solution is charged to make the nanoparticles of the second group of element oxides precipitate, and the mixture of these nanoparticles is recovered.
Alternatively
C: The following steps (1) and (2) are successively performed:
(1) A first solution of salts of the first group of elements which form the thermoelectric conversion material and a second solution of a precursor of the second group of elements which form the phonon scattering particles are formed so as to satisfy the following condition 1.
Condition 1] The salts and the precursor are selected so that in the presence of the same reducing agent, the speed by which the salts are reduced and the nanoparticles of the first group of elements precipitate becomes greater than the speed by which the precursor polymerizes and the nanoparticles of the second group of element oxides precipitate.
(2) A reducing agent is mixed with the first solution to make the nanoparticles of the first group of elements precipitate, this is allowed to stand to cause aggregation, then the second solution is charged to make the nanoparticles of the second group of element oxides precipitate, and the mixture of these nanoparticles is recovered.
Next, the second stage successively performs the following steps (3) and (4).
(3) Said mixture is hydrothermally treated to alloy the nanoparticles of the first group of elements and the nanoparticles of the second group of element oxides to obtain composite nanoparticles.
(4) Said composite nanoparticles are sintered to obtain a bulk material.

3. The method of production of a nanocomposite thermoelectric conversion material according to claim 1 further comprising selecting the first group of elements from Si, Bi, Sb, Te, and Se.

4. The method of production of a nanocomposite thermoelectric conversion material according to any one of claim 1 further comprising selecting the second group of elements from Si, Bi, Sb, Te, Se, Ti, and Al.
